(19) United States
(12) Patent Application Publication
(10) Pub. No.: US 2025/0263114 A1
(43) Pub. Date: Aug. 21, 2025

(54) TORQUE SIGNAL PROCESSING METHOD, EPS SENSOR, AND STORAGE MEDIUM

(71) Applicant: SAIC GM Wuling Automobile Co., Ltd., Guangxi (CN)

(72) Inventors: Juncheng LV, Guangxi (CN); Min Wei, Guangxi (CN); Bin Li, Guangxi (CN); Xiaomeng Wang, Guangxi (CN); Fan Bai, Guangxi (CN)

(73) Assignee: SAIC GM Wuling Automobile Co., Ltd., Guangxi (CN)

(21) Appl. No.: 19/197,231

(22) Filed: May 2, 2025

Related U.S. Application Data
(63) Continuation of application No. PCT/CN2025/072165, filed on Jan. 14, 2025.

(30) Foreign Application Priority Data
Jan. 29, 2024 (CN) 202410123586.4

(51) Int. Cl. B62D 5/04; H02P 27/08

(52) U.S. Cl. CPC B62D 5/0463; H02P 27/085

(57) ABSTRACT

Provided is a torque signal processing method, an EPS sensor, and a storage medium. The method includes: determining a duty cycle of a first PWM signal according to a first voltage collected by a first torque sensor, an average initial voltage, and a conversion coefficient; and determining a duty cycle of a second PWM signal according to a second voltage collected by a second torque sensor, the average initial voltage, and the conversion coefficient. The average initial voltage is calculated according to a first and second initial voltages respectively collected by the first and second torque sensors when torque is 0, and the duty cycle of the first PWM signal and the duty cycle of the second PWM signal are determined according to the first voltage collected by the first torque sensor, the second voltage collected by the second torque sensor, the average initial voltage, and the conversion coefficient.

### CROSS-REFERENCE TO RELATED APPLICATIONS

The present application is a continuation of International Application No. PCT/CN2025/072165, filed on Jan. 14, 2025, which claims priority to Chinese Patent Application No. 202410123586.4, filed on Jan. 29, 2024, the entire contents of which are incorporated herein by reference.

### TECHNICAL FIELD

The present disclosure relates to the technical field of signal processing, and in particular, to a torque signal processing method, an electronic power steering (EPS) sensor, and a storage medium.

### BACKGROUND

A torque sensor in an EPS system serves as a sensing element of the EPS and is configured to convert torque of a steering shaft of a vehicle steering wheel into a voltage signal. The EPS determines, based on the voltage signal, a magnitude of power provided for the steering shaft. Therefore, the accuracy of the voltage signal detected by the torque sensor is closely related to accuracy of the EPS system.

Generally, in practical application, there is a need to convert the voltage signal detected by the torque sensor into a pulse width modulation (PWM) signal, and then control the power of the EPS system through the PWM signal. For example, the PWM signal may be obtained by subtracting an initial voltage corresponding to the torque sensor from the voltage signal detected by the torque sensor and according to a conversion relationship between the voltage and the PWM signal. The initial voltage is a voltage detected by the torque sensor when the torque is 0.

However, in practical applications, due to external electromagnetic interference or internal structure, the initial voltage of the torque sensor is inaccurate, which results in a considerable error in the PWM signal, thereby affecting accuracy of the EPS system.

It is to be noted that the information disclosed in the Background portion of the present disclosure is only for ease of understanding of the general background art of the present disclosure and should not be taken as acknowledgment or any form of suggestion that the information constitutes the prior art technologies already known to those skilled in the art.

### SUMMARY

In view of this, the present disclosure provides a torque signal processing method, an EPS sensor, and a storage medium, to help solve the problem of a considerable error in the PWM signal in the prior art.

In a first aspect, an embodiment of the present disclosure provides a torque signal processing method, including: determining a duty cycle of a first PWM signal according to a first torque signal collected by a first torque sensor, the duty cycle of the first PWM signal is used to represent first torque detected by the first torque sensor; and determining a duty cycle of a second PWM signal according to a second torque signal collected by a second torque sensor, the duty cycle of the second PWM signal is used to represent second torque detected by the second torque sensor.

In a possible embodiment, the determining a duty cycle of a first PWM signal according to a first torque signal collected by a first torque sensor includes: determining the duty cycle of the first PWM signal according to a first voltage collected by the first torque sensor, an average initial voltage, and a conversion coefficient; and the determining a duty cycle of a second PWM signal according to a second torque signal collected by a second torque sensor includes: determining the duty cycle of the second PWM signal according to a second voltage collected by the second torque sensor, the average initial voltage, and the conversion coefficient. The average initial voltage is an average value of a first initial voltage collected by the first torque sensor and a second initial voltage collected by the second torque sensor, and the first initial voltage and the second initial voltage are respectively voltage values collected by the first torque sensor and the second torque sensor when the torque is 0.

In a possible embodiment, the first torque sensor and the second torque sensor are arranged symmetrically, so that a first torque theoretical value detected by the first torque sensor and a second torque theoretical value detected by the second torque sensor are equal in magnitude and opposite in direction.

In a possible embodiment, the determining the duty cycle of the first PWM signal according to a first voltage collected by the first torque sensor, an average initial voltage, and a conversion coefficient includes: calculating a difference between the first voltage collected by the first torque sensor and the average initial voltage to obtain a first relative voltage; and determining the duty cycle of the first PWM signal according to the first relative voltage and the conversion coefficient; and the determining the duty cycle of the second PWM signal according to a second voltage collected by the second torque sensor, the average initial voltage, and the conversion coefficient includes: calculating a difference between the second voltage collected by the second torque sensor and the average initial voltage to obtain a second relative voltage; and determining the duty cycle of the second PWM signal according to the second relative voltage and the conversion coefficient.

In a possible embodiment, the determining the duty cycle of the first PWM signal according to a first voltage collected by the first torque sensor, an average initial voltage, and a conversion coefficient includes: determining the duty cycle of the first PWM signal according to a formula T_{1′}=X+K(V_{A}−(V_{A0}+V_{B0})/2), where T_{1′} denotes the duty cycle of the first PWM signal, X denotes a preset duty cycle parameter, K denotes the conversion coefficient, V_{A} denotes the first voltage collected by the first torque sensor, V_{A0} denotes the first initial voltage, and V_{B0} denotes the second initial voltage; and the determining the duty cycle of the second PWM signal according to a second voltage collected by the second torque sensor, the average initial voltage, and the conversion coefficient includes: determining the duty cycle of the second PWM signal according to a formula T_{2′}=X−K((V_{A0}+V_{B0})/2−V_{B0}), where T_{2′} denotes the duty cycle of the second PWM signal, X denotes the duty cycle parameter, K denotes the conversion coefficient, V_{B} denotes the second voltage collected by the second torque sensor, V_{A0} denotes the first initial voltage, and V_{B0} denotes the second initial voltage.

In a possible embodiment, X is 50%.

In a possible embodiment, the method further includes: determining a first standard duty cycle according to a formula T₁″=Y+(T_{1′}−T_{2′})/2, where T₁″ denotes the first standard duty cycle; and determining a second standard duty cycle according to a formula T₂″=Y−(T_{1′}−T_{2′})/2, where T₂″ denotes the second standard duty cycle.

In a possible embodiment, Y is 50%.

In a possible embodiment, prior to the determining the duty cycle of the first PWM signal according to a first voltage collected by the first torque sensor, an average initial voltage, and a conversion coefficient, the method further includes: sampling a first voltage analog signal outputted by the first torque sensor to obtain the first voltage collected by the first torque sensor; and sampling a second voltage analog signal outputted by the second torque sensor to obtain the second voltage collected by the second torque sensor.

In a possible embodiment, the method further includes: determining an average initial voltage according to a first initial voltage collected by the first torque sensor and a second initial voltage collected by the second torque sensor when the torque is 0.

In a second aspect, an embodiment of the present disclosure provides an EPS sensor, including: a first torque sensor; a second torque sensor; and a controller configured to perform the method according to any of the embodiments in the first aspect.

In a third aspect, an embodiment of the present disclosure provides a non-transitory computer-readable storage medium, the computer-readable storage medium includes a program stored therein. The program, when run, controls a device where the computer-readable storage medium is located to perform the method according to any of the embodiments in the first aspect.

In a fourth aspect, an embodiment of the present disclosure provides a vehicle, including: the EPS sensor in the second aspect.

In the solutions provided in embodiments of the present disclosure, the average initial voltage is calculated according to the first initial voltage collected by the first torque sensor and the second initial voltage collected by the second torque sensor when the torque is 0, and the duty cycle of the first PWM signal and the duty cycle of the second PWM signal are determined according to the first voltage collected by the first torque sensor, the second voltage collected by a second torque sensor, the average initial voltage, and the conversion coefficient. By use of the solutions provided in embodiments of the present disclosure, the initial voltage is an average initial voltage, when the torque detected by one torque sensor deviates greatly from a theoretical value and the torque detected by the other torque sensor deviates slightly from the theoretical value, an offset generated between the torque sensors can be equalized and then averaged and distributed after comparison with the theoretical value, which effectively improves accuracy of the duty cycles of the PWM signals actually outputted by the sensors.

### BRIEF DESCRIPTION OF DRAWINGS

In order to more clearly illustrate the technical solutions in embodiments of the present disclosure, the accompanying drawings used in the description of the embodiments will be briefly introduced below. It is apparent that the accompanying drawings in the following description are only some embodiments of the present disclosure, and other drawings can be obtained by those of ordinary skill in the art from the provided drawings without creative efforts.

FIG. 1 is a schematic diagram of an application scenario of EPS in the related art;

FIG. 2 is a schematic structural diagram of an EPS sensor according to an embodiment of the present disclosure;

FIG. 3 is a schematic flowchart of a torque signal processing method according to an embodiment of the present disclosure;

FIG. 4 is a schematic flowchart of another torque signal processing method according to an embodiment of the present disclosure; and

FIG. 5 is a schematic structural diagram of an EPS sensor according to an embodiment of the present disclosure.

### DESCRIPTION OF EMBODIMENTS

In order to better understand the technical solutions of the present disclosure, embodiments of the present disclosure will be described in detail below with reference to the accompanying drawings.

It should be clear that the described embodiments are only some of rather than all of embodiments of the present disclosure. Based on the embodiments in the present disclosure, all other embodiments obtained by those of ordinary skill in the art without creative efforts fall within the scope of protection of the present disclosure.

The terms used in embodiments of the present disclosure are only for the purpose of describing specific embodiments and are not intended to limit the present disclosure. As used in embodiments of the present disclosure and the appended claims, the singular forms of “a/an”, “one”, and “the” are intended to include plural forms, unless otherwise clearly indicated in the context.

It should be understood that the term “and/or” used herein is merely an association relationship describing associated objects, indicating that three relationships may exist. For example, A and/or B may indicate that there are three cases of A alone, A and B together, and B alone. In addition, the character “/” herein generally indicates an “or” relationship between the associated objects.

An EPS system is a power steering system that directly relies on an electric motor to provide assist torque. During actual use of a vehicle, EPS receives steering wheel torque exerted on a steering wheel by a driver and a steering wheel angle that are collected by various sensors, then calculates assist torque, converts the assist torque into a current instruction of an assist motor, and controls the assist motor to generate corresponding assist torque. The assist torque is amplified by a gear reduction mechanism and then acts on a steering gear. Finally, the driver is assisted in overcoming steering resistance torque, realizing steering of the vehicle.

For ease of understanding, a detailed description is given below in conjunction with the accompanying drawings and specific embodiments.

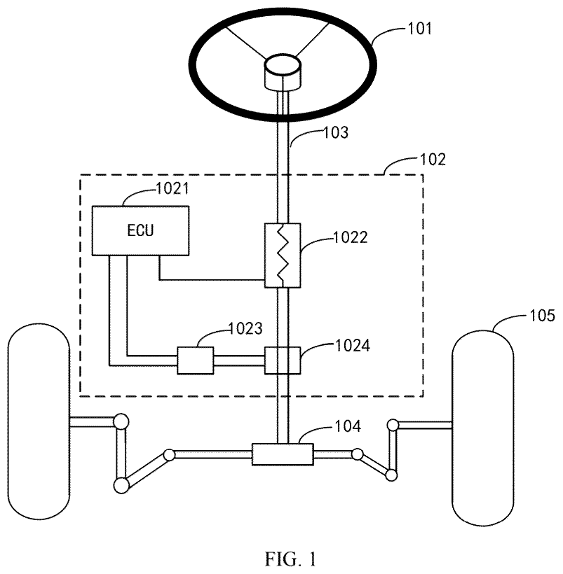

Refer to FIG. 1 which is a schematic diagram of an application scenario of EPS in the related art. As shown in FIG. 1, a steering wheel 101, an EPS system 102, a steering shaft 103, a rack and pinion steering gear 104, and tires 105 are illustrated in the application scenario. The EPS system 102 includes, for example, an electronic control unit (ECU) 1021, an EPS sensor 1022, an assist motor 1023, and a gear reduction mechanism 1024.

As shown in FIG. 1, the steering wheel 101 controls steering of the tires 105 through the steering shaft 103 and the rack and pinion steering gear 104. The EPS sensor 1022 is configured to collect torque on the steering shaft 103. The ECU 1021 outputs, according to a received torque signal, an assist motor control instruction corresponding to the torque signal. The assist motor 1023 assists the gear reduction mechanism 1024 in applying assist torque to the steering shaft 103, to assist rotation of the steering shaft 103.

During actual use, when the driver turns the steering wheel 101, the steering wheel 101 drives the steering shaft 103 to rotate. In this case, the EPS sensor 1022 transmits, to the ECU 1021, a collected torque signal indicating rotation of the steering shaft 103. The ECU 1021 controls, based on the received torque signal, the assist motor 1023 to drive the gear reduction mechanism 1024 to rotate, thereby assisting the rotation of the power steering shaft 103, and finally drives the rack and pinion steering gear 104 to control steering of the tires 105.

It is to be noted that FIG. 1 is merely an exemplary illustration of the application scenario as referred to in embodiments of the present disclosure, and should not be used to limit the scope of protection of the present disclosure. Further, it may be understood that the EPS sensor 1022 is merely an example, which may alternatively be an angle sensor or a torque angle sensor (the torque angle sensor is integrated with a torque sensor and an angle sensor). The sensor type is not limited in the present disclosure.

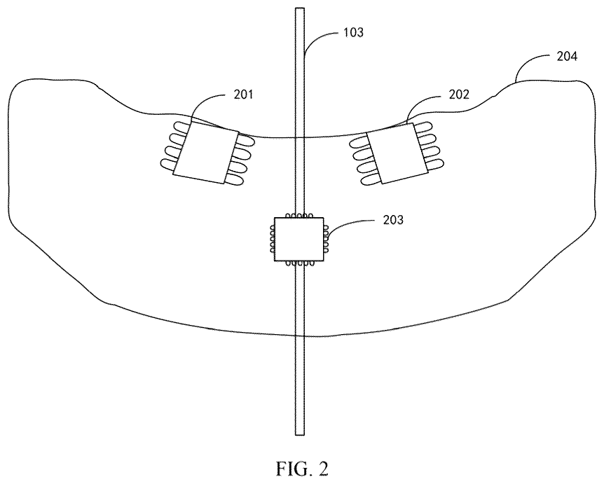

Refer to FIG. 2 which is a schematic structural diagram of an EPS sensor according to an embodiment of the present disclosure. As shown in FIG. 2, in this embodiment, the EPS sensor includes a first torque sensor 201, a second torque sensor 202, and a controller 203 that are arranged on a circuit board 204. The first torque sensor 201 and the second torque sensor 202 are symmetrically arranged on two sides of the steering shaft 103, so that first torque detected by the first torque sensor 201 and second torque detected by the second torque sensor 202 are equal in magnitude and opposite in direction.

When the steering shaft 103 rotates clockwise (that is, the torque is positive), the first torque detected by the first torque sensor 201 gradually increases, and the second torque detected by the second torque sensor 202 gradually decreases. When the steering shaft 103 rotates counterclockwise (that is, the torque is negative), the first torque detected by the first torque sensor 201 gradually decreases, and the second torque detected by the second torque sensor 202 gradually increases.

That is, after the first torque sensor 201 and the second torque sensor 202 convert the torque into voltage signals, when the steering shaft 103 rotates clockwise (that is, the torque is positive), a first voltage V_{A} collected by the first torque sensor 201 increases according to a preset gradient, and a second voltage V_{B} collected by the second torque sensor 202 decreases according to the same gradient, i.e., V_{A}−2.5=2.5−V_{B}. When the steering shaft 103 rotates counterclockwise (that is, the torque is negative), the first voltage V_{A} collected by the first torque sensor 201 decreases according to the preset gradient, and the second voltage V_{B} collected by the second torque sensor 202 increases according to the same gradient, i.e., 2.5−V_{A}=V_{B}−2.5. That is, the first voltage V_{A} and the second voltage V_{B} satisfy |V_{A}−2.5|=|2.5−V_{B}|. After the EPS sensor converts the voltages into duty cycles of PWM signals, a duty cycle T₁ of a first PWM signal and a duty cycle T₂ of a second PWM signal should satisfy |T₁−50%|=|50%−T₂|. It is to be noted that since the first torque sensor 201 and the second torque sensor 202 are symmetrically arranged, in order to save cost, a low-specification microcontroller unit (MCU) chip is used in the present disclosure. Therefore, in embodiments of the present disclosure, 2.5 V is selected as a relative value within an effective range of the torque sensor (0.5 V to 4.5 V) to ensure sampling accuracy.

Voltage values collected by the two torque sensors and the duty cycles of the corresponding PWM signals under ideal conditions are described in the above embodiments. However, in practical applications, due to hardware or structural problems, an electromagnetic torque sensor is susceptible to electromagnetic interference, resulting in a considerable error in the voltage values collected by the two torque sensors relative to a theoretical value. It is to be noted that the theoretical value is obtained through experimental calibration of the torque sensor. Due to different factors such as a model, a manufacturer, and manufacturing accuracy of the torque sensor, the theoretical value obtained is also different. The theoretical value as referred to herein is a calibration result determined from these different results in accordance with appropriate rules that comply with international requirements and thus does not belong to the prior art. When the torque is 0, a first initial voltage detected by the first torque sensor is V_{A0}, and a second initial voltage detected by the second torque sensor is V_{B0}. Due to the hardware or structural problems of the electromagnetic torque sensor above, V_{A0} and V_{B0} are often not the theoretical value of 2.5 V, and offsets of V_{A0} and V_{B0} relative to 2.5 V are also different. That is, |V_{A}−V_{A0}|≠|V_{B0}−V_{B}|. In the related art, a voltage value is directly converted into a PWM duty cycle, and then |T₁−50%|≠|50%−T₂|.

To solve this problem, an embodiment of the present disclosure provides a torque signal processing method, in which the initial voltage is an average initial voltage, when the torque detected by one torque sensor deviates greatly from the theoretical value and the torque detected by the other torque sensor deviates slightly from the theoretical value, an offset of the torque detected by the two torque sensors relative to the theoretical value can be averaged, so that an error in a duty cycle of an actually outputted PWM signal is smaller. A detailed description is provided hereinafter.

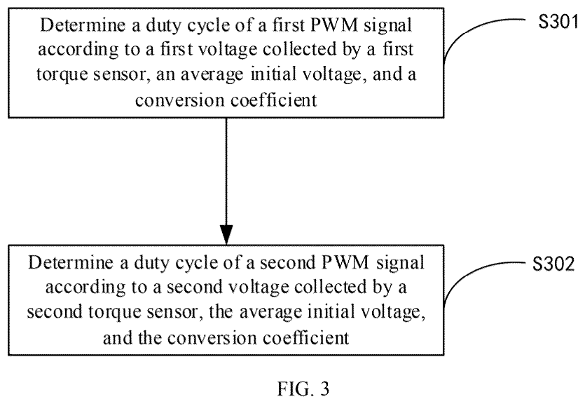

Refer to FIG. 3 which is a schematic flowchart of a torque signal processing method according to an embodiment of the present disclosure. The method is applicable to the application scenario shown in FIG. 1. As shown in FIG. 3, the method mainly includes the following steps.

In step S301, a duty cycle of a first PWM signal is determined according to a first voltage collected by a first torque sensor, an average initial voltage, and a conversion coefficient.

Before converting a voltage analog signal, the controller is required to sample a voltage signal first. For example, a first voltage analog signal outputted by the first torque sensor is sampled to obtain the first voltage collected by the first torque sensor. The controller samples a second voltage analog signal outputted by the second torque sensor to obtain the second voltage collected by the second torque sensor. In a possible embodiment, the voltage signal collected by the torque sensor is a voltage analog signal, and the controller is a MCU chip equipped with an AD conversion port. The AD conversion port is an analog identification port, which can identify a voltage value within a certain voltage range and convert the voltage value into a corresponding digital form for use by the controller. A voltage analog signal outputted by the first torque sensor is sampled through the AD conversion port of the controller to obtain the first voltage. The AD conversion port of the controller samples a voltage analog signal outputted by the second torque sensor to obtain the second voltage.

When the torque is 0, the voltage collected by the first torque sensor is a first initial voltage, and the voltage collected by the second torque sensor is a second initial voltage. When the voltage is converted into a PWM signal, if the first voltage minus the first initial voltage is directly multiplied by the conversion coefficient, it may lead to a considerable error between the duty cycle of the obtained PWM signal and the theoretical value. To avoid this problem, in embodiments of the present disclosure, the average initial voltage may be obtained by averaging the first initial voltage and the second initial voltage. A difference between the first voltage collected by the first torque sensor and the average initial voltage is calculated, to obtain a first relative voltage. The duty cycle of the first PWM signal is determined according to the first relative voltage and the conversion coefficient. The conversion coefficient is a conversion coefficient for converting a voltage analog signal into a PWM signal.

In embodiments of the present disclosure, the duty cycle of the first PWM signal is calculated according to a formula T_{1′}=X+K(V_{A}−(V_{A0}+V_{B0})/2), where T_{1′} denotes the duty cycle of the first PWM signal, X denotes a preset duty cycle parameter, K denotes the conversion coefficient, V_{A} denotes the first voltage collected by the first torque sensor, V_{A0} denotes the first initial voltage, and V_{B0} denotes the second initial voltage. X may be 50%. It is to be noted that since the first torque sensor and the second torque sensor are physically arranged symmetrically about the steering shaft in embodiments of the present disclosure, 50% is set as the preset duty cycle parameter. It is understandable that, those skilled in the art may replace the preset duty cycle parameter X with any value according to actual design distribution, for example, by setting X to 30%, 60%, or 70% according to a relative deviation angle asymmetrically designed, which is not limited in embodiments of the present disclosure.

In practical applications, a signal type outputted by the torque sensor is generally a voltage analog signal. However, since the voltage analog signal has a poor anti-interference capability, in embodiments of the present disclosure, after the first torque sensor and the second torque sensor output voltage analog signals, the controller converts voltages in the voltage analog signals into duty cycles of PWM signals, to improve an anti-interference capability of an outputted signal.

In step S302, a duty cycle of a second PWM signal is determined according to a second voltage collected by a second torque sensor, the average initial voltage, and the conversion coefficient.

For example, a difference between the second voltage collected by the second torque sensor and the average initial voltage is calculated, to obtain a second relative voltage. The duty cycle of the second PWM signal is determined according to the second relative voltage and the conversion coefficient.

In embodiments of the present disclosure, the duty cycle of the second PWM signal is calculated according to a formula T_{2′}=X−K((V_{A0}+V_{B0})/2−V_{B}), where T_{2′} denotes the duty cycle of the second PWM signal, X denotes the preset duty cycle parameter, K denotes the conversion coefficient, V_{B} denotes the second voltage collected by the second torque sensor, V_{A0} denotes the first initial voltage, and V_{B0} denotes the second initial voltage. X may be 50%. It is understandable that, those skilled in the art may replace the preset duty cycle parameter X with any value according to an actual requirement, for example, 30%, 60%, or 70%, which is not limited in embodiments of the present disclosure.

It may be understood that in order to control a calculation amount of the controller, the controller, when processing the first voltage collected by the first torque sensor, uses the formula T_{1′}=X+K(V_{A}−(V_{A0}+V_{B0})/2). That is, when the torque is positive (that is, the steering shaft rotates clockwise), the first voltage is greater than 2.5 V, and T_{1′} is calculated by using the formula T_{1′}=X+K(V_{A}−(V_{A0}+V_{B0})/2). In this case, the first relative voltage is positive. When the torque is negative (that is, the steering shaft rotates counterclockwise), the first voltage is less than 2.5 V, and T_{1′} is calculated still by using the formula. In this case, the first relative voltage is negative. Similarly, the controller, when processing the second voltage collected by the second torque sensor, uses the formula T_{2′}=X−K((V_{A0}+V_{B0})/2−V_{B}). That is, when the torque is positive (that is, the steering shaft rotates clockwise), the second voltage is less than 2.5 V, and T_{2′} is calculated by using the formula T_{2′}=X−K((V_{A0}+V_{B0})/2−V_{B}). In this case, the second relative voltage is negative. When the torque is negative (that is, the steering shaft rotates counterclockwise), the second voltage is greater than 2.5 V, and T_{2′} is calculated still by using the formula. In this case, the second relative voltage is positive.

Based on the above, the average initial voltage is calculated according to a first initial voltage collected by the first torque sensor and a second initial voltage collected by the second torque sensor when the torque is 0, and the duty cycle of the first PWM signal and the duty cycle of the second PWM signal are determined according to the first voltage collected by the first torque sensor, the second voltage collected by a second torque sensor, the average initial voltage, and the conversion coefficient. By use of the solution provided in embodiments of the present disclosure, the initial voltage is an average initial voltage, when the torque detected by one torque sensor deviates greatly from the theoretical value and the torque detected by the other torque sensor deviates slightly from the theoretical value, an offset of the torque detected by the two torque sensors relative to the theoretical value can be averaged, so that an error in a duty cycle of a PWM signal actually outputted is smaller.

The above controller is located in the EPS sensor. A PWM signal outputted by the controller is a signal outputted by the EPS sensor. When the EPS sensor outputs the PWM signal to the EPS controller, there may be problems such as signal distortion or signal interference, causing the signal received by the EPS controller to be inconsistent with the signal outputted by the EPS sensor. To verify whether the signal received by the EPS controller is consistent with the signal outputted by the EPS sensor, an embodiment of the present disclosure provides another torque signal processing method, which is described in detail hereinafter.

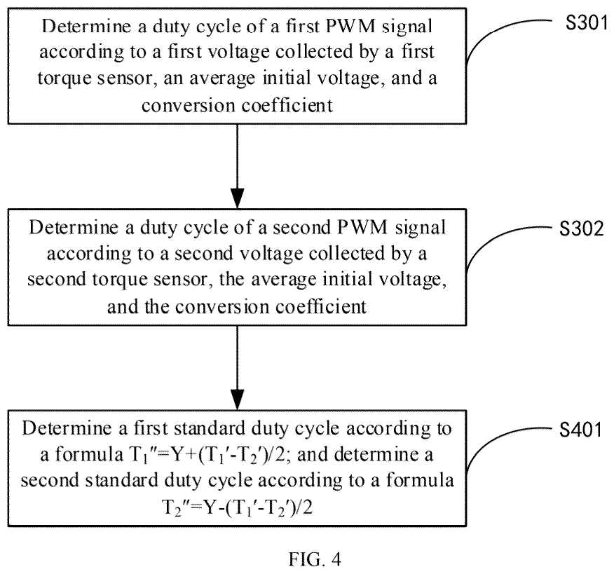

Refer to FIG. 4 which is a schematic flowchart of another torque signal processing method according to an embodiment of the present disclosure. As shown in FIG. 4, the method further includes the following steps based on the embodiment shown in FIG. 3.

In step S401, a first standard duty cycle is determined according to a formula T₁″=Y+(T_{1′}−T_{2′})/2; and a second standard duty cycle is determined according to a formula T₂″=Y−(T_{1′}−T_{2′})/2.

For example, the duty cycle T_{1′} of the first PWM signal and the duty cycle T_{2′} of the second PWM signal are substituted into the formula T₁″=Y+(T_{1′}−T_{2′})/2, to determine the first standard duty cycle T₁″. The duty cycle T_{1′} of the first PWM signal and the duty cycle T_{2′} of the second PWM signal are substituted into the formula T₂″=Y−(T_{1′}−T_{2′})/2, to obtain the second standard duty cycle T₂″. In embodiments of the present disclosure, Y is 50%. It is understandable that, those skilled in the art may replace the preset standard duty cycle parameter Y with any value according to an actual requirement, for example, 30%, 60%, or 70%, which is not limited in embodiments of the present disclosure.

It may be understood that in order to control a calculation amount of the controller, the controller, when calculating the first standard duty cycle, uses the formula T₁″=Y+(T_{1′}−T_{2′})/2. That is, when the torque is positive (that is, the steering shaft rotates clockwise), the first voltage is greater than 2.5 V and the second voltage is less than 2.5 V. In this case, the obtained T_{1′} is greater than T_{2′}. The first standard duty cycle T₁″ is calculated by using the formula T₁″=Y+(T_{1′}−T_{2′})/2. In this case, the first standard duty cycle is greater than Y Similarly, when the torque is negative (that is, the steering shaft rotates counterclockwise), the first voltage is less than 2.5 V and the second voltage is greater than 2.5 V. In this case, the obtained T_{1′} is less than T_{2′}. The first standard duty cycle T₁″ is calculated still by using the formula T₁″=Y+(T_{1′}−T_{2′})/2. In this case, the first standard duty cycle is less than Y Similarly, the controller, when calculating the second standard duty cycle, uses the formula T₂″=Y−(T_{1′}−T_{2′})/2. That is, when the torque is positive (that is, the steering shaft rotates clockwise), the first voltage is greater than 2.5 V and the second voltage is less than 2.5 V. In this case, the obtained T_{1′} is greater than T_{2′}. The second standard duty cycle T₂″ is calculated by using the formula T₂″=Y−(T_{1′}−T_{2′})/2. In this case, the second standard duty cycle is less than Y Similarly, when the torque is negative (that is, the steering shaft rotates counterclockwise), the first voltage is less than 2.5 V and the second voltage is greater than 2.5 V In this case, the obtained T_{1′} is less than T_{2′}. The second standard duty cycle T₂″ is calculated still by using the formula T₂″=Y−(T_{1′}−T_{2′})/2. In this case, the second standard duty cycle is greater than Y.

Through step S401, the first standard duty cycle T₁″ and the second standard duty cycle T₂″ satisfy |T₁″−50%|=|50%−T₂″|. After receiving a PWM signal outputted by the EPS sensor, an EPS controller may first verify whether the first standard duty cycle T₁″ and the second standard duty cycle T₂″ satisfy |T₁″−50%|=|50%−T₂″ |. If yes, it indicates that there are no problems such as signal distortion or signal interference during signal transmission. That is, the first standard duty cycle T₁″ and the second standard duty cycle T₂″ are reliable. If not, it indicates that there are problems such as signal distortion or signal interference during signal transmission. That is, the first standard duty cycle T₁″ and the second standard duty cycle T₂″ are unreliable. Then, the EPS controller may mark T₁″ and T₂″ and output an error message. Through mutual verification of the two PWM signals, security of the signal transmission process is verified.

Through mutual verification of the two PWM signals, the EPS controller receives a reliable signal, so that when the EPS controller provides power to the steering shaft based on the signal, the deviation is smaller, which means that the user feels smooth when turning the steering wheel, thereby improving user experience.

In practical applications, the torque sensor may fail. When a short circuit or open circuit fault occurs in the torque sensor, a voltage collected by the faulty torque sensor cannot be used as an input voltage. In a possible embodiment, when the voltage collected by the torque sensor falls within a first voltage range or a second voltage range, it may be determined that a fault occurs in the torque sensor. The first voltage range is a voltage range close to a minimum range in a range of the voltage collected by the torque sensor, and the second voltage range is a voltage range close to a maximum range in the range of the voltage collected by the torque sensor. In embodiments of the present disclosure, the range of the voltage collected by the torque sensor is 0 to 5 V, the first voltage range is 0 to 0.5V, and the second voltage range is 4.5 to 5 V. When the voltage collected by the torque sensor is in the range of 0 to 0.5 V or 4.5 to 5 V, the duty cycle of the PWM signal corresponding to the voltage analog signal is 0 to 12.5% or 87.5% to 100%. That is, when the duty cycle of the PWM signal outputted is 0 to 12.5% or 87.5% to 100%, it may be determined that a fault occurs in the torque sensor. It is understandable that, those skilled in the art may set the fault voltage and the corresponding duty cycle to other values according to an actual requirement, which is not limited in embodiments of the present disclosure.

Since there is a one-to-one mapping relationship between duty cycles of PWM signals and torque, a duty cycle of a PWM signal may reflect magnitude of current torque. In a possible embodiment, the mapping relationship between duty cycles of PWM signals and torque may be represented by a table. As shown in Table I, when the duty cycle of the first PWM signal is 87.5% and the duty cycle of the second PWM signal is 12.5%, the torque is 12 N m. When the duty cycle of the first PWM signal is 50% and the duty cycle of the second PWM signal is 50%, the torque is 0 N·m. When the duty cycle of the first PWM signal is 12.5% and the duty cycle of the second PWM signal is 87.5%, the torque is −12 N·m. In addition, theoretically, a sum of the duty cycle of the first PWM signal and the duty cycle of the second PWM signal is 100%, and the duty cycles of the two PWM signals can verify mutual accuracy. For example, as shown in Table I, if the sum of the duty cycle of the first PWM signal 87.5%) and the duty cycle of the second PWM signal 12.5% is 100%, the first PWM signal and the second PWM signal are accurate, and if the sum of the duty cycle of the first PWM signal and the duty cycle of the second PWM signal is not equal to 100%, one or both of the first PWM signal and the second PWM signal are inaccurate.

TABLE I

| Duty cycle of first PWM | Duty cycle of second PWM | | |
|---|---|---|---|
| signal | signal | Torque | |
| 87.5% | 12.5% | 12 | N · m |
| 50% | 50% | 0 | N · m |
| 12.5% | 87.5% | −12 | N · m |

For example, when the torque of the steering shaft 103 is 12 N·m, the first voltage collected by the first torque sensor 201 is 4.5 V, and the second voltage collected by the second torque sensor 202 is 0.5 V. After the first voltage is converted into the first PWM signal, the duty cycle of the first PWM signal is 87.5%. After the second voltage is converted into the second PWM signal, the duty cycle of the second PWM signal is 12.5%. Similarly, when the torque of the steering shaft 103 is −12 N·m, the first voltage collected by the first torque sensor 201 is 0.5 V, and the second voltage collected by the second torque sensor 202 is 4.5 V. After the first voltage is converted into the first PWM signal, the duty cycle of the first PWM signal is 12.5%. After the second voltage is converted into the second PWM signal, the duty cycle of the second PWM signal is 87.5%.

Through a corresponding relationship between duty cycles of PWM signals and torque as well as the duty cycle of the first PWM signal and the duty cycle of the second PWM signal, the magnitude of the torque detected by the first torque sensor and the second torque sensor can be determined.

Corresponding to the above embodiments, the present disclosure further provides an EPS sensor.

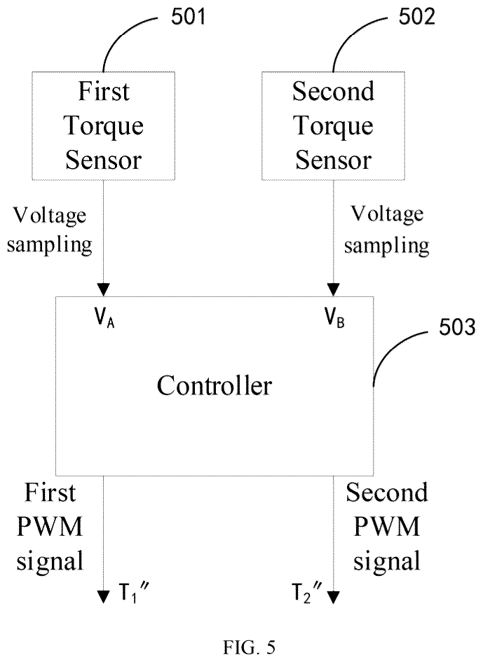

Refer to FIG. 5 which is a schematic structural diagram of an EPS sensor according to an embodiment of the present disclosure. As shown in FIG. 5, the EPS sensor includes a first torque sensor 501, a second torque sensor 502, and a controller 503.

The first torque sensor 501 is configured to collect first torque and output a first voltage analog signal.

The second torque sensor 502 is configured to collect second torque and output a second voltage analog signal.

The controller 503 is configured to perform voltage sampling on the first voltage analog signal and the second voltage analog signal, determine a duty cycle of a first PWM signal according to a first voltage collected by a first torque sensor, an average initial voltage, and a conversion coefficient, and determine a duty cycle of a second PWM signal according to a second voltage collected by a second torque sensor, the average initial voltage, and the conversion coefficient.

In a possible embodiment, as shown in FIG. 5, the controller 503 is an 8-bit MCU chip. Two AD conversion ports of the MCU chip respectively perform voltage sampling on the voltage analog signals outputted by the two torque sensors to obtain the first voltage V_{A} and the second voltage V_{B}. The MCU chip processes the first voltage V_{A} and the second voltage V_{B} to obtain the corresponding first PWM signal and the corresponding second PWM signal, and outputs a first duty cycle T₁″ and a second duty cycle T₂″ respectively at two output terminals of the MCU chip. It is understandable that, those skilled in the art may set the controller to another apparatus according to an actual requirement, which is not limited in embodiments of the present disclosure.

An embodiment of the present disclosure further provides a non-transitory computer storage medium. The computer storage medium may have a program stored therein. The program, when executed, may include some or all of the steps in embodiments of the torque signal processing method provided in embodiments of the present disclosure. The storage medium may be a magnetic disk, an optical disc, a read-only memory (ROM), a random access memory (RAM), or the like.

In embodiments of the present disclosure, “at least one” refers to one or more, and “a plurality of” refers to two or more. “And/or” is an association relationship describing associated objects, indicating that three relationships may exist. For example, A and/or B may indicate that there are three cases of A alone, A and B together, and B alone. A and B may be singular or plural. The character “/” generally indicates an “or” relationship between the associated objects. “At least one of the following” and similar expressions refers to any combination of these items, including any combination of a single item or a plurality of items. For example, at least one of a, b, and c may represent a, b, c, a and b, a and c, b and c, or a and b and c. Herein, a, b, and c may be in singular form or plural form.

Those of ordinary skill in the art may be aware that units and algorithm steps described in the embodiments disclosed herein may be implemented by electronic hardware or a combination of computer software and electronic hardware. Whether the functions are performed by hardware or software depends on particular applications and design constraints of the technical solutions. Those skilled in the art may use different methods to implement the described functions for each particular application, but it should not be considered that the implementation goes beyond the scope of the present disclosure.

It may be clearly understood by those skilled in the art that, for the purpose of convenient and brief description, for a detailed operating process of the foregoing systems, apparatuses, and units, refer to a corresponding process in the foregoing method embodiments. Details are not described herein again.

In the embodiments provided in the present disclosure, when any of the functions are implemented in the form of a software functional unit and sold or used as an independent product, the functions may be stored in a computer-readable storage medium. Based on such understanding, the technical solutions of the present disclosure essentially, or the part contributing to the prior art, or some of the technical solutions may be implemented in the form of a software product. The computer software product may be stored in a storage medium, and includes several instructions for instructing a computer device (which may be a personal computer, a server, a network device, or the like) to perform all or some of the steps of the methods described in embodiments of the present disclosure. The storage medium includes any medium that can store program code, such as a USB flash drive, a removable hard disk, a ROM, a RAM, a magnetic disk, or an optical disc.

The same and similar parts among the various embodiments in the present disclosure may be referred to each other. In particular, for the apparatus embodiments and the terminal embodiments, since they are basically similar to the method embodiments, the description is relatively simple. For relevant details, please refer to the description in the method embodiments.

What is claimed is:

1. A torque signal processing method, comprising:
determining a duty cycle of a first pulse width modulation (PWM) signal according to a first torque signal collected by a first torque sensor, wherein the duty cycle of the first PWM signal is configured to represent a first torque detected by the first torque sensor; and
determining a duty cycle of a second PWM signal according to a second torque signal collected by a second torque sensor, wherein the duty cycle of the second PWM signal is configured to represent second torque detected by the second torque sensor.

2. The method according to claim 1, wherein
the determining a duty cycle of a first PWM signal according to a first torque signal collected by a first torque sensor comprises: determining the duty cycle of the first PWM signal according to a first voltage collected by the first torque sensor, an average initial voltage, and a conversion coefficient; and
the determining a duty cycle of a second PWM signal according to a second torque signal collected by a second torque sensor comprises: determining the duty cycle of the second PWM signal according to a second voltage collected by the second torque sensor, the average initial voltage, and the conversion coefficient;
wherein the average initial voltage is an average value of a first initial voltage collected by the first torque sensor and a second initial voltage collected by the second torque sensor, and the first initial voltage and the second initial voltage are respectively voltage values collected by the first torque sensor and the second torque sensor when the torque is 0.

3. The method according to claim 1, wherein the first torque sensor and the second torque sensor are arranged symmetrically, so that a first torque theoretical value detected by the first torque sensor and a second torque theoretical value detected by the second torque sensor are equal in magnitude and opposite in direction.

4. The method according to claim 2, wherein
the determining the duty cycle of the first PWM signal according to a first voltage collected by the first torque sensor, an average initial voltage, and a conversion coefficient comprises:
calculating a difference between the first voltage collected by the first torque sensor and the average initial voltage to obtain a first relative voltage; and determining the duty cycle of the first PWM signal according to the first relative voltage and the conversion coefficient; and
the determining the duty cycle of the second PWM signal according to a second voltage collected by the second torque sensor, the average initial voltage, and the conversion coefficient comprises: calculating a difference between the second voltage collected by the second torque sensor and the average initial voltage to obtain a second relative voltage; and determining the duty cycle of the second PWM signal according to the second relative voltage and the conversion coefficient.

5. The method according to claim 4, wherein
the determining the duty cycle of the first PWM signal according to a first voltage collected by the first torque sensor, an average initial voltage, and a conversion coefficient comprises:
determining the duty cycle of the first PWM signal according to a formula T_{1′}=X+K(V_{A}−(V_{A0}+V_{B0})/2), where T_{1′} denotes the duty cycle of the first PWM signal, X denotes a preset duty cycle parameter, K denotes the conversion coefficient, V_{A} denotes the first voltage collected by the first torque sensor, V_{A0} denotes the first initial voltage, and V_{B0} denotes the second initial voltage; and
the determining the duty cycle of the second PWM signal according to a second voltage collected by the second torque sensor, the average initial voltage, and the conversion coefficient comprises: determining the duty cycle of the second PWM signal according to a formula T_{2′}=X−K((V_{A0}+V_{B0})/2−V_{B}), where T_{2′} denotes the duty cycle of the second PWM signal, X denotes the duty cycle parameter, K denotes the conversion coefficient, V_{B} denotes the second voltage collected by the second torque sensor, V_{A0} denotes the first initial voltage, and V_{B0} denotes the second initial voltage.

6. The method according to claim 5, wherein X is 50%.

7. The method according to claim 1, further comprising:
determining a first standard duty cycle according to a formula T₁″=Y+(T_{1′}−T_{2′})/2, wherein T₁″ denotes the first standard duty cycle, and Y denotes a preset standard duty cycle parameter; and
determining a second standard duty cycle according to a formula T₂″=Y−(T_{1′}−T_{2′})/2, wherein T₂″ denotes the second standard duty cycle, and Y denotes the preset standard duty cycle parameter.

8. The method according to claim 7, wherein Y is 50%.

9. The method according to claim 2, wherein prior to the determining the duty cycle of the first PWM signal according to a first voltage collected by the first torque sensor, an average initial voltage, and a conversion coefficient, the method further comprises:
sampling a first voltage analog signal outputted by the first torque sensor to obtain the first voltage collected by the first torque sensor; and
sampling a second voltage analog signal outputted by the second torque sensor to obtain the second voltage collected by the second torque sensor.

10. The method according to claim 1, wherein the method further comprises:
determining an average initial voltage according to a first initial voltage collected by the first torque sensor and a second initial voltage collected by the second torque sensor when the torque is 0.

11. An electronic power steering (EPS) sensor, comprising:
a first torque sensor;
a second torque sensor; and
a controller configured to perform the method according to claim 1.

12. A non-transitory computer-readable storage medium, comprising a program stored therein, wherein the program, when run, controls a device where the computer-readable storage medium is located to perform the method according to claim 1.
